(19) United States
(12) Patent Application Publication
(10) Pub. No.: US 2017/0252650 A1
(43) Pub. Date: Sep. 7, 2017

(54) METHOD FOR GUIDING A USER IN AN ELECTRONIC GAME OR OTHER ENVIRONMENT

(71) Applicant: WEALTH WIZARDS LIMITED, Stratford-Upon-Avon (GB)

(72) Inventor: Tony VAIL, Stratford-Upon-Avon (GB)

(21) Appl. No.: 15/510,829

(22) PCT Filed: Sep. 15, 2015
(86) PCT No.: PCT/GB2015/052662

§ 371 Date: Mar. 13, 2017

(30) Foreign Application Priority Data
Sep. 15, 2014 (GB) 1416284.6
Sep. 15, 2014 (GB) 1416285.3
Nov. 10, 2014 (GB) 1419949.1
Apr. 20, 2015 (GB) 1506620.2

(51) Int. Cl. A63F 13/533; G06Q 40/06; A63F 13/822; A63F 13/25; A63F 13/803; A63F 13/837

(52) U.S. Cl. CPC A63F 13/533; A63F 13/803; A63F 13/837; A63F 13/822; A63F 13/25; G06Q 40/06

(57) ABSTRACT

In an electronic game or other environment, a graphical user interface (GUI) receives and responds to a user's inputs and present data to the user on a display device. A processor executes computer instructions for responding to the user's inputs and manipulating the graphical user interface. The processor is configured to: (a) present two opposing outcomes on the GUI, together with a selection mechanism that extends between or otherwise relates to the two outcomes; and (b) receive an input from the graphical user interface corresponding to an action by the user in controlling the selection mechanism in a way that expresses the user's relative preference for each opposing outcome.

### BACKGROUND OF THE INVENTION

1. Field of the Invention

This invention relates to a method for guiding a user in an electronic game or other environment.

2. Description of the Prior Art

Computer games present the user with the ability to define characters, control the choices they make and shape their journey through the game's many challenges. Enabling the player to understand what choices are available to an in-game character at any particular time, especially where different choices lead to divergent outcomes, is usually binary. For example, an in-game character could be given the choice of multiple lives, e.g. regenerating three times, or the choice of great physical strength, but to have just a single life; the game mechanic or rule set could then require the game player to choose which option he wants. This is a binary choice mechanism—the game player chooses either multiple lives or great physical strength, but not both. He is forced into deciding which of these two binary outcomes he prefers.

The aim of this invention is to provide a mechanic that enables complex and subtler decision making to be achieved by the user, especially between multiple sets of competing outcomes.

The mechanic can be used in games for entertainment, or other contexts in which a player or other kind of user interacts with software to express complex behavioural choices for a character.

### SUMMARY OF THE INVENTION

The invention is a method for guiding a user in an electronic game or other environment, comprising the steps:
a graphical user interface (GUI) receiving and responding to a user's inputs and present data to the user on a display device;
and a processor executing computer instructions for responding to the user's inputs and manipulating the graphical user interface, the processor configured to:

(a) present two opposing outcomes on the GUI, together with a selection mechanism that extends between or otherwise relates to the two outcomes; and

(b) receive an input from the graphical user interface corresponding to an action by the user in controlling the selection mechanism in a way that expresses the user's relative preference for each opposing outcome.

### BRIEF DESCRIPTION OF THE DRAWINGS

FIG. 1 shows a GUI showing five pairs of outcomes; the user sets a slider to show their relative preference for each outcome.

### DETAILED DESCRIPTION

An implementation of the invention guides a user in an electronic game or other environment through a sequence of questions which present two opposing outcomes, together with a selection mechanism that extends between or otherwise relates to the two outcomes. The user then controls the selection mechanism in a way that expresses the user's relative preference for each opposing outcome.

For example, the selection mechanism could be a slider GUI that extends between the two incompatible outcomes and the user can then set the slider at the desired position between the two outcomes. The slider could be continuously variable, or could move in discrete jumps.

The selection mechanism could be an array of buttons (e.g. a line of five or more radio style buttons) that extends between the two incompatible outcomes and the user can then choose the button that best expresses their choice.

So for example, the options in a ‘Quest’ type game playing context could be to define one set of attributes of the player's in-game character:
Careful planning v Impetuous Courage

The user can now set e.g. the slider anywhere along the continuum—he could choose his character to have 100% ‘Impetuous Courage’ and hence 0% ‘careful planning’, or vice versa, or anything in-between, like 30% ‘careful planning’ and ‘70% ‘impetuous courage’, or 60% ‘careful planning’ and ‘40%’ impetuous courage’. This mechanic reflects the reality that making choices is generally a zero-sum game—there is a trade-off between the two outcomes and one cannot have both 100% ‘careful planning’ and at the same time 100% ‘impetuous courage’ attributes.

Other designs of selection mechanism are possible: the selection mechanism could for example be an icon, such as a swing or seesaw, pivoting mid-way between each outcome, that can be tipped up or down to indicate the user's relative preference for each opposing outcome.

In many cases, the trade-off is between certainty and flexibility. To return to the very first example above, one could have the certainty of knowing that your in-game character can re-generate three times, or the flexibility of having a physical attribute such as great strength since this could lead to many different positive outcomes (e.g. winning fights, running fast to evade attackers etc.) all of which could be highly relevant to the ultimate aim of the game (e.g. typically reaching a goal of some sort).

There will generally be many such choices to be made when constructing the attributes of a character. The software engine will then combine all the resulting choices made into a character with attributes that best fits the complex traits defined by this mechanism; the eventual outcome is hence the sum total of a series of complex and graduated compromises between pairs of opposed or incompatible outcomes and hence much richer than conventional ways of capturing traits, such as simple binary choices.

One especially challenging context for surfacing how a player wishes a character to behave is where the character is actually the player himself and the player is faced with real-world dilemmas or choices, especially where those choices involve trade-offs between behaviours or goals that are incompatible. For example, the player could be defining financial planning scenarios or outcomes using a computer system; conventionally, that computer system could simply ask for specific information (e.g. “Do you want a guaranteed income?”), but this approach fails to capture the impact that different choices will have on the player being able to reach the desired outcomes, and even the fact that choices are necessarily being made between incompatible goals.

Considerable skill needs to be exercised by the software designer in identifying choices that are realistic and engaging and that require genuine trade-offs to be made; enabling the user to define the relative preference between multiple sets of incompatible outcomes enables some deep insight into the user's preferences that cannot be directly ascertained.

For example, in the game playing context, assume the aim of the game is a car racing game; the goal then is to win a race. The game player could then be faced with setting the slider control (or buttons or whichever control mechanism is used) somewhere between each of the following attributes:
Maneuverability v straight line speed
Power v fuel consumption
Wages for your driver v waves for your chief mechanic
Resources spent optimizing aerodynamic efficiency v resources spent optimizing engine performance

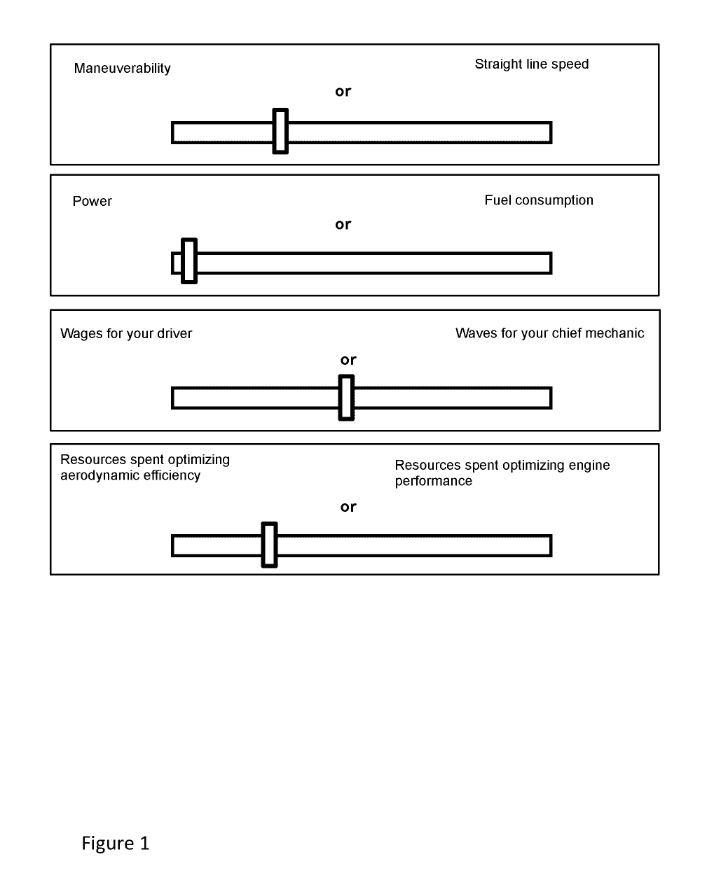

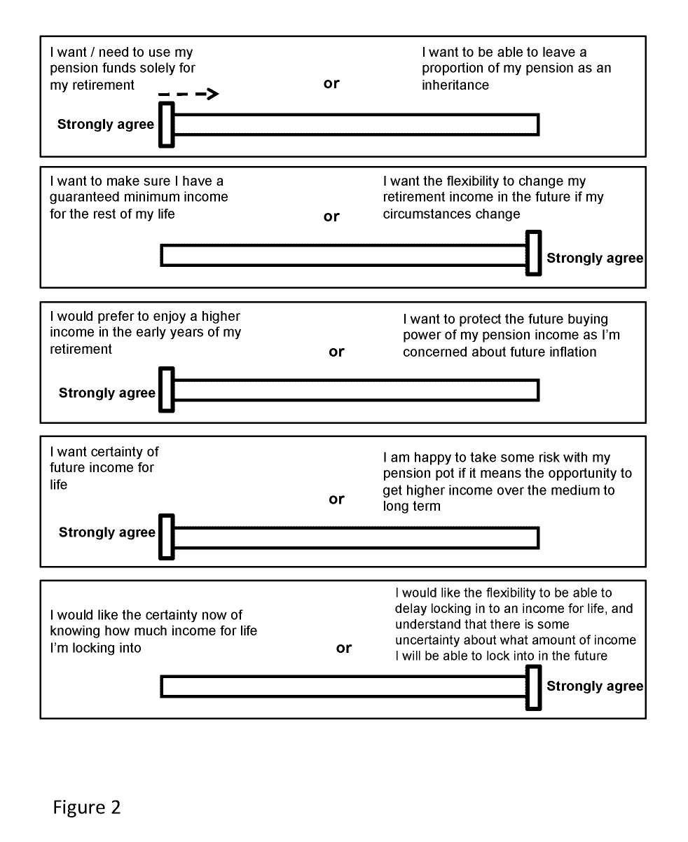

FIG. 1 shows where a user has placed the slider control for each of these four different parameters, showing: a slight preference for maneuverability over straight line speed, which might be the right decision if the racing track has lots of tight corners and few long straights; a strong preference for power over fuel consumption, which be might the right decision if the race is likely to be a short one and re-fueling strategies not influential; a even balance between wages for the driver and chief mechanic; and a slight preference Resources spent optimizing aerodynamic efficiency as against resources spent optimizing engine performance.

The resultant set of parameters can then be used by the games engine to define all the variable parameters of the virtual car and its performance that will be driven by the player and the driver; these parameters of the car and driver can then be combined with the real-time inputs from the game player's console whilst actually racing in a game to determine how the virtual car actually performs in a virtual race. Because of the richness of inputs and the fact that they reflect the real-world practical constraints that car designers need to operate under, the overall game experience is more realistic and engaging.

And in the financial scenario planning context, we can also present multiple different outcomes. The user could then be faced with setting the slider control (or buttons or whichever control mechanism is used) somewhere between each of the attributes given in Appendix 1 and as shown in FIG. 2. In FIG. 2, the user has placed the slider in the extreme positions for each question, but in practice can place them anywhere along the line, just as in the racing car game example given above: a more nuanced set of inputs can hence be captured, reflecting the nuanced approach people often have to decision making in this area.

In the retirement planning scenario, the various choices could be structured so that setting the slider at a specific position generates an index which illustrates the user's preference for flexibility (high score) vs certainty (low score) in terms of retirement income and benefits. The index is then used as part of an advice engine to provide personalised recommendations to the user. The index score (and description related to score level) could also be revealed to the user as the output from a standalone tool.

This approach can cover 3 or more mutually incompatible goals—this would be achieved by the same mechanism, i.e. still presenting 2 mutually incompatible goals that the user expresses preference between, but then cycling through all the unique trade-offs and then using conjoint analysis (e.g. 3 goals—test 1 vs 2, test 1 vs 3, test 2 vs 3).

It might be useful to note the similarities between some genres of conventional computer games, such as quest-type or racing type games, and financial planning software each implementing this invention. The actual experience of playing say a quest-type or racing type games, and completing financial planning scenario is not dis-similar. In each:
The user selects or defines attributes of a character (and in the case of the financial planning software, this is auto-biographical)
The user defines the preferences between different explicit outcomes and these choices are analysed and determine future preferences or behavior
The process of asking oneself how one should choose between different outcomes is in both case the task of constructing a character; it is, in the retirement scenario planning context, a form of journey thought one's life choices and the trajectory of the plot (inevitably leading to old age, and then death) as engaging as any novel.

APPENDIX 1

| | |
|---|---|
| I want/need to use my | I want to be able to |
| pension funds solely | leave a proportion |
| for my retirement | of my pension as |
| | an inheritance |
| I want to make sure | I want the flexibility |
| I have a guaranteed | to change my |
| minimum income for | retirement income |
| the rest of my life | in the future if my |
| | circumstances change |
| I would prefer to enjoy | I want to protect the future |
| a higher income | buying power of my |
| in the early years | pension income as I'm |
| of my retirement | concerned about |
| | future inflation |
| I want certainty of | I am happy to take |
| future income for life | some risk with my |
| | pension pot if it |
| | means the opportunity |
| | to get higher income |
| | over the medium to |
| | long term |
| I would like the certainty | I would like the |
| now of knowing | flexibility to be able |
| how much income | to delay locking in to |
| for life I'm locking | an income for life, and |
| into | understand there is some |
| | uncertainty about what |
| | amount of income |
| | I will be able to lock |
| | into in the future |

1. A method for guiding a user in an electronic game or other environment, comprising the steps:
a graphical user interface (GUI) receiving and responding to a user's inputs and present data to the user on a display device;
and a processor executing computer instructions for responding to the user's inputs and manipulating the graphical user interface, the processor configured to:
(a) present two opposing outcomes on the GUI, together with a selection mechanism that extends between or otherwise relates to the two outcomes; and
(b) receive an input from the graphical user interface corresponding to an action by the user in controlling the selection mechanism in a way that expresses the user's relative preference for each opposing outcome.

2. The method of claim 1 in which the selection mechanism is a slider GUI that extends between the two incompatible outcomes and the user can then set the slider at the desired position.

3. The method of claim 1 in which the slider could be continuously variable, or could move in discrete jumps.

4. The method of claim 1 in which the selection mechanism is an array of buttons that extends between the two incompatible outcomes and the user can then choose the button that best expresses their choice.

5. The method of claim 4 in which the array is a line of five or more radio style buttons

6. The method of claim 1 in which the selection mechanism is an icon, such as a swing or seesaw pivoting mid-way between each outcome, that can be tipped up or down to indicate the user's relative preference for each opposing outcome.

7. The method of claim 1 in which there are multiple sets of paired opposing outcomes, each presented to the user

8. The method of claim 1 in which the environment is a video game, such as a roll playing video game, quest game play, strategy game, sports game, shooter game, fighting game, or car racing game.

9. The method of claim 1 in which the environment is a financial scenario planning software, such as retirement planning.

10. The method of claim 9 in which the various incompatible options are structured so that controlling the selection mechanism to express the relative preference between each set of incompatible outcomes then generates a score, such as an index, which illustrates the preference for flexibility (high score) vs certainty (low score) in terms of retirement income and benefits.

11. The method of claim 10 in which the index is used as part of an advice engine to provide personalised recommendations to the user.
